(19) United States
(12) Patent Application Publication
(10) Pub. No.: US 2005/0239558 A1
(43) Pub. Date: Oct. 27, 2005

(54) Self-forming sleeve for shaft coupling

(76) Inventors: David D. Brandt, Milwaukee, WI (US); Wayne H. Wielebski, New Berlin, WI (US)

Correspondence Address: Alexander M. Gerasimow;Allen-Bradley Company, LLC, 1201 South Second Street, Milwaukee, WI, 53204-2496, US

(21) Appl. No.: 10/831,826

(22) Filed: Apr. 26, 2004

(51) Int. Cl. F16D 3/52

(52) U.S. Cl. 464/89

(57) ABSTRACT

A technique is provided for defining a self-forming sleeve between a male shaft and a female or hollow shaft. The self-forming sleeve prevents wear and fretting at the interface between the male shaft and the hollow shaft while permitting torque to be transmitted through the interface. The self-forming sleeve may be made of a curable liquid, such as an adhesive or sealing compound. The sleeve material is applied either to the hollow bore, to the male shaft, or to both immediately prior to an assembly step. Following curing or bonding of the self-forming sleeve, the sleeve will not drain, flow or otherwise be extruded from the interface between the male shaft and hollow bore, providing continued operation with a minimal degree of wear and fretting at the interface. The self-forming sleeve allows the mating male and hollow shafts to be disassembled, after extensive periods of operation, without excessive force and without significant damage to shafts and connected machinery.

### BACKGROUND

The present invention relates generally to rotary power transmission devices, and more particularly to an arrangement for transmitting torque between a male shaft and a female or hollow shaft, such as a hub or quill shaft.

Many applications exist in industrial and commercial settings for transmitting rotary power between a driving machine and a driven machine. Power is generally transmitted from a driving shaft on the driving machine to a driven shaft on the driven machine.

In rotating machinery of the type mentioned above, various arrangements are known and are presently in use for coupling the driving and driven shafts. In certain arrangements, a male driving shaft (extending from a motor, a gear reducer, or some other type of equipment) and a male driven shaft are coupled through a coupling arrangement which is interposed between the shafts. In other arrangements, a hub or female or hollow member receives the male driving shaft, typically with the male shaft extending from the driving equipment and a female or hollow hub, on the driven machine being adapted to mate with the male driving shaft. In still other arrangements, a female shaft, commonly referred to as a “quill shaft” may extend from the driven load and present an aperture in which a male driving shaft is inserted for driving the quill or hollow end shaft. In certain devices, the quill shaft may be supported at a single end or both ends within the driven device.

For example, in certain worm drive gear reducers, the quill shaft may be supported at an extremity thereof opposite a drive shaft, with driving shaft bearings serving to support both the driving shaft and the quill shaft at the input end of the quill shaft. In other arrangements, an additional bearing may be supplied at the quill shaft input end. In yet another arrangement the driving shaft in the driving machine may be a hollow shaft or quill. The driven shaft in this case would be male and would be configured to extend into the female or hollow driving shaft.

Depending upon the alignment of the driving shaft and the mating driven shaft angular displacement of the male shaft with respect to the female shaft may occur during each rotational cycle. That is, unless exactly aligned coaxially, the shafts will undergo some relative movement in rotation due to slight misalignment. This is particularly problematic in the case of hollow shafts and similar arrangements, where substantial wear, and fretting may take place at the interface between the male shaft and the internal surface of the hollow shaft. Over time, if such fretting is allowed to continue, degradation of one or both shafts may occur, or the shafts may even undergo welding in which the shafts ultimately are fused to one another and cannot be separated. Such wear, fretting, and welding degrades the operation of one or both devices, and ultimately results in maintenance cost, primarily in replacement of parts or the entire machines themselves, as well as downtime and labor costs.

Attempts have been made to ameliorate the interface between male shafts and female or hollow members, such as quill shafts. For example, in certain environments, inserts, such as plastic sleeves, may be provided between hollow shafts and male shafts to absorb wear or at least to absorb the movement of misalignment. However, the presence of such sleeves implies that the desired torque available from the driving machine cannot be provided to the driven machine without either enlarging one or both shafts. Typically, the arrangement must be oversized or down rated to accommodate the smaller male shaft that is inserted into the intermediary sleeve, or the hollow shaft enlarged to the size required to accommodate the internally-fitting sleeve. Greases and lubricants have also been used in the interface between the male shafts and hollow shafts. However, such temporary measures have been found inadequate, and eventually are worn or eliminated from the interface, permitting fretting, wear and eventual welding of the interface.

There is a need, therefore, for an improved technique for mating male shafts and hollow shafts, such as quill shafts.

### BRIEF DESCRIPTION

The present invention provides a novel approach to coupling male shafts and hollow members, such as quill shafts, designed to respond to such needs. The technique makes use of a direct connection between the male shaft and the hollow member, with driving between the shafts being accomplished by any suitable torque-transmitting feature. Such features might include keys, splines, and so forth. A layer of conforming material is disposed between the male shaft and the interior surface of the hollow member. The conforming material may be inserted in a liquid form or a semi-liquid form. The material is then cured or bonded to establish a barrier between the male shaft and the interior surface of the hollow member. This self-forming sleeve allows the mating male and hollow shafts to be disassembled, after extensive periods of operation, without excessive force and without significant damage to shafts and connected machinery.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of a gear reducer and electric motor embodying a typical application for the present technique for coupling a hollow member or bore with a male shaft;

FIG. 2 is a partially cut-away view of the gear reducer of FIG. 1 illustrating certain internal components of the machine in this typical application of the present techniques;

FIG. 3 is a sectional view through a portion of the hollow shaft of the gear reducer of FIGS. 1 and 2 coupled to the male shaft of a driving electric motor as shown in FIG. 1 and illustrating a present embodiment for coupling the components via a self-forming sleeve;

FIG. 4 is a detailed view of a portion of the interface of the hollow bore and male shaft illustrated in FIG. 3;

FIG. 5 is a partially sectioned end view of the hollow bore and male shaft coupled to one another in accordance with aspects of the present technique taken along line 5-5 in FIG. 3; and

FIG. 6 is a flow chart illustrating exemplary steps in coupling the machines illustrated in the previous figures, and for installing the self-forming sleeve in accordance with aspects of the present technique.

### DETAILED DESCRIPTION

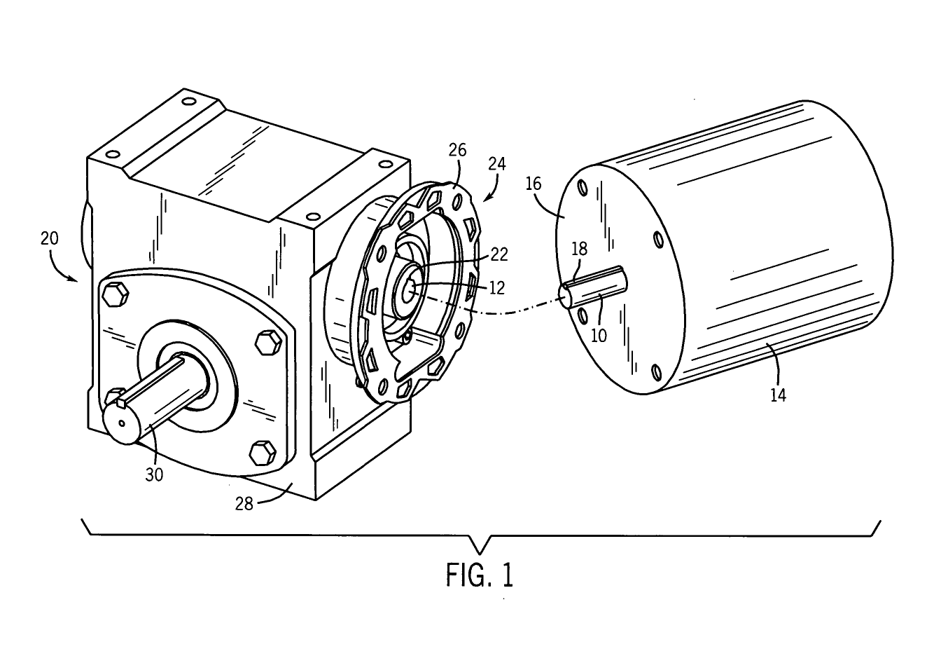

Turning now to the drawings, and referring first to FIG. 1, an exemplary application of the present technique is illustrated. In particular, the application provides for drivingly coupling a male shaft 10 within a hollow bore 12. In the illustrated embodiment, the shaft 10 extends from a driving electric motor 14 which, in the illustrated embodiment, is designed for direct coupling to the driven system via a standard C-face. The male shaft drives the machine, once coupled, via a key 18 installed in a conventional manner in the shaft.

The driven machine, in the embodiment illustrated in the figures, is a 90 degree gear reducer 20 in a form of a worm-drive reducer. The hollow bore 12 is provided with a keyway 22 designed to interface with the key 18 of the shaft 10 when the male shaft is inserted into the hollow bore. An input interface is provided on the gear reducer 20 to receive the driving electric motor 14. In the illustrated embodiment, the input interface 24 presents a peripheral flange 26 designed to receive and support the motor, and to maintain the motor in general alignment so as to support the male shaft 10 within the hollow bore 12 in a generally coaxial alignment. The flange is supported on a housing 28 within which internal components provide for gear reduction and drive an output shaft 30 which extends from the housing.

It should be noted that the particular application illustrated in the figures is provided for exemplary purposes only. In general, the present techniques allow for installing a self-forming sleeve at an interface between a male shaft and a hollow member, such as a bore. However, while a key-drive is illustrated in the figures, other types of torque-transmitting members may be employed, including multiple keys, splines, straight shafts set within a hub via set screws or other torque transmitting elements, and so forth. Similarly, the hollow bore 12 in the gear reducer illustrated in the figures may present conforming features to mate with those of the male shaft. Other types of mounting arrangements than those shown in the figures may, of course, be provided for the mated members. Indeed, in certain applications, the components may not be directly coupled as shown in the figures, but may be linked by intermediate components, such as mounting adapters, mounting feet, couplings, and so forth. Finally, while the application in a gear reducer, and more particularly to a hollow (quill) shaft, as discussed in greater detail below, is a particularly well-suited application, the present technique may find significant utility and other environments and applications. These applications may or may not involve speed or torque reduction or entries.

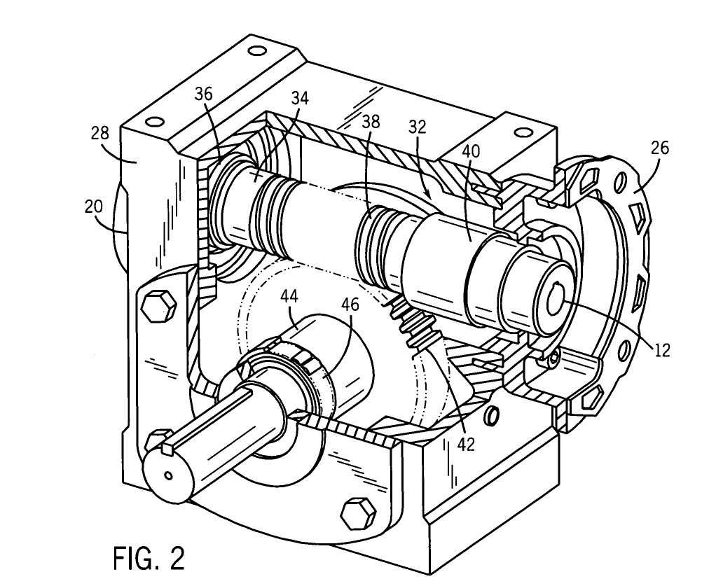

FIG. 2 illustrates the gear reducer 20 of FIG. 1 in somewhat greater detail, with a portion of the housing 28 being broken away to display the inner components of the machine. As noted above, the housing 28 supports an input flange at the input interface which is designed to receive and support a driving electric motor. The bore 12 is formed in a quill shaft 32 which extends through the housing 28 and is supported at a rear extension 34. In the illustrated embodiment, the extension 34 of the quill shaft 32 is supported by a rear bearing assembly 36. The shaft then includes a worm gear section 38 designed to drive the gear reducer when the shaft is driven in rotation by the electric motor. At a forward end 40 of the quill shaft 32, no similar bearing is provided in the illustrated embodiment. When assembled with the driving motor, then, the interior bearings of the electric motor supporting shaft 10 (see FIG. 1) aides to support the end 40 of the quill shaft 32 during operation. In other embodiments, the quill shaft 32 may be supported by bearings on both ends. However, the unsupported end 40 of the quill shaft is particularly problematic in terms of wear between the bore and shaft as discussed in greater detail below.

In the embodiment of the gear reducer illustrated in FIG. 2, the worm gear section 38 of the quill shaft 32 drives a gear 42 in rotation. The gear 42 is mounted on a shaft 44 which, in the illustrated embodiment, is the same shaft 30 that extends from the gear reducer as illustrated in FIG. 1. Bearings support shaft 44 in rotation and absorb loads on the shaft during operation, a forward bearing 46 only being illustrated in the figures. As will be appreciated by those skilled in the art, during operation, the output shaft of the reducer is rotated at a lesser speed than the input shaft (quill shaft 32), as defined by the pitch of the worm gear section 38, and the diameter of the gear 42. Complex loading is experienced by both shafts, with particularly problematic loading being experienced by the quill shaft, which is resisted by the bearings supporting the quill shaft, and by the interface between the quill shaft and the male shaft.

As will be appreciated by those skilled in the art, substantial wear and fretting may take place at an interface between the bore 12 of the quill shaft and the male shaft 10 illustrated in FIGS. 1 and 2. It has been found that such wear is particularly pronounced in certain types of applications, and with certain types and sizes of input power. For example, single-phase motors operating at asynchronous speed of 1800 RPM have been found particularly problematic in such direct-coupled quill shaft applications. Vibrational patterns established between the rotating elements during operation can cause non-coaxial loading of the interface that, over time, can substantially wear or even weld the services together at the interface. The present technique provides for a self-forming sleeve that absorbs such loading and precludes wear and welding at the interface.

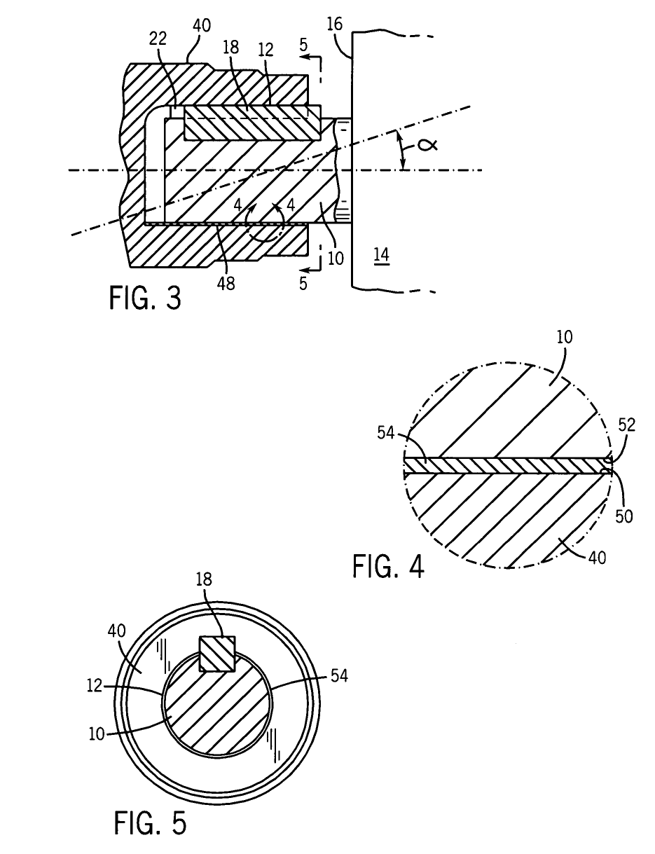

FIG. 3 illustrates an exemplary configuration of a mated hollow member, in the form of the end 40 of quill shaft 32 illustrated in the previous figures, mounted to a male shaft, such as shaft 10 extending from a driving electric motor as discussed above. In the illustrated embodiment, some misalignment is illustrated (greatly exaggerated in the figure) and indicated by the angle α. FIG. 3 illustrates an embodiment similar to that of the previous figures, wherein the shaft 10 drives the end 40 of the driven member in rotation via a key 18 disposed in appropriate keyways in the male shaft and hollow member. The shaft 10 and bore 12 are sized to provide a slip or press fit therebetween, while allowing some small peripheral area to receive an interface material 48 therebetween. The interface material 48 is applied to the male shaft and/or the bore during the assembly process as discussed below. Thereafter, the interface material is cured and forms a semi-permanent barrier which absorbs loading and wear, preventing wear on either the male shaft or bore, while permitting torque to be transmitted therebetween with virtually no loss of torque-transmitting rating either by increase of the bore dimension or decrease in the male shaft dimension.

FIG. 4 illustrates a detail of a portion of the interface between the male shaft 10 and quill bore 40 of FIG. 3. As shown in FIG. 4, the quill bore 40 has a peripheral surface 50 which is in close proximity to the outer surface 52 of the male shaft 10 following assembly. In practice, there may be some contact between the surfaces, although some interstice or interstices are preferably left to receive the interface material 48 discussed above, which defines a self-forming sleeve 54 following assembly. This arrangement is illustrated in the end view of FIG. 5. Following assembly, the male shaft 10 extends into the quill bore 12 in a normal fashion, with the torque-transmitting members, such as key 18, placed therebetween. The self-forming sleeve 54 is effectively an interface layer between the quill bore and the male shaft, permitting torque to be transmitted therebetween, but limiting wear due to any misalignment α (see FIG. 3) between the driving and driven components.

In accordance with the preferred embodiment of the present technique, the self-forming sleeve 54 comprises a low strength adhesive barrier that remains flexible during operation of the machine. That is, the barrier is preferably of a low stiffness, but is not fluid following application and installation. One exemplary material that has been found to provide good results is commercially available from Loctite Industrial Adhesives, a division of Henkel Technologies, under the designation PST 567, which is generally used as a thread sealing compound. This product is a paste-like anaerobic compound stays relatively liquid or semi-liquid with exposure to oxygen, but will cure once placed into the interstice between the rotating members in the present technique. The compound employed in current embodiments has an approximately 24 hour cure time, after which it essentially loses its fluid properties and becomes a semi-permanent sleeve between the components. That is, the component can be disassembled, but the self-forming sleeve will not leak or be extruded from the interface during normal operation. Other suitable materials are believed to include two-part epoxies, such as epoxies available for repairing polyvinylchloride components.

It should be noted that as used herein, the terms “curing” and “curable” are not intended to connote any particular type of chemical or material process, but should be broadly understood to mean a change in physical properties by which the material will resist flowing from or being eliminated from the location between the shaft and bore in which the self-forming sleeve is installed. A number of materials, with various physical property-changing processes may be appropriate for use as the self-forming sleeve. These might include various adhesives and sealants. Compounds that change viscoelastic properties, compounds that solidify or “set up”, bond, link, cross link, or from which solvents leach or evaporate to provide the desired plastic properties needed to conform to the interstice between the shaft and bore, and yet remain sufficiently elastic during operation to work effectively as a protective sleeve.

In the present embodiment, the press or slip fit between the male shaft and the quill bore provides an approximately 0.0005-0.0015 inch clearance. This clearance, then defines the approximate thickness of the self-forming sleeve. Other fits and clearances may, of course, be used, depending upon such factors as the rotational speed of the equipment, the radius of the rotational members at the interface, the degree of misalignment anticipated, and the material provided for the self-forming sleeve. In experimental applications, the foregoing arrangement was employed to drive a quill shaft-driven gear reducer by a single-phase motor. While previous techniques employing lubricants may have generated vibration and wear-originating noise after mere minutes of operation, the present technique was found to operate quietly after 1500 hours of continuous operation, indicating significantly less contact and wear at the interface.

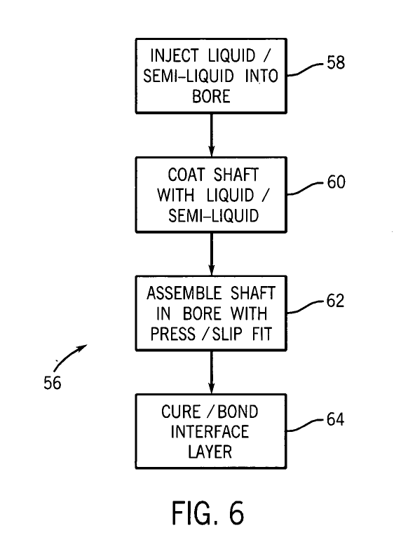

FIG. 6 summarizes exemplary steps in the process for installing the self-forming sleeve in accordance with the present technique. The process, designated generally by reference numeral 56 in FIG. 6, begins with injection of the liquid or semi-liquid sleeve material into the hollow bore, as indicated at step 58. Similarly, at step 60, the male shaft to be inserted into the bore is coated with the liquid or semi-liquid material used to form the sleeve. In actual practice, the material may have a consistency similar to an adhesive or paste. Moreover, one or both of steps 58 and 60 may be performed in certain applications. That is, the self-forming sleeve material may be coated on the shaft without injecting into the bore, or the material may be provided on the inner surface of the bore without also coating the shaft.

At step 62 the male shaft and hollow bore are assembled by the press or slip fit described above. In a typical application, the assembly may be accompanied by assembly of other components, such as securing a motor to a mounting adapter in the embodiment described above. The interface layer is then allowed to cure and bond as indicated at step 64. In certain present embodiments, the material employed does not form a strong bond to the metal of either the male shaft or the hollow bore, but forms a flexible interface therebetween. Following the curing and bonding step 64, the machine may be placed in operation and torque applied to the driven machine through the intermediary of the self-forming sleeve while avoiding wear and degradation of either the male shaft or the hollow bore due to any misalignment at the interface.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for coupling a male shaft with a hollow member, the method comprising:
disposing a curable interface material in a region between an outer surface of a male shaft and an inner surface of a hollow member, the interface material contacting both the outer surface and the inner surface; and
curing the interface material in situ between the shaft and the hollow member.

2. The method of claim 1, wherein the curable interface material is applied to the outer surface of a male shaft prior to assembly of the male shaft in the hollow member.

3. The method of claim 1, wherein the curable interface material is applied to the inner surface of the hollow member prior to assembly of the male shaft in the hollow member.

4. The method of claim 1, wherein the curable interface material is disposed between the shaft and the hollow member in a liquid or semi-liquid state.

5. The method of claim 4, wherein the curable interface material remains liquid prior to curing, and thereafter forms a flexible but solid barrier layer between the male shaft and the hollow member.

6. The method of claim 1, wherein the curable interface material remains liquid or semi-liquid when exposed to air, and becomes solid when removed from air.

7. The method of claim 1, wherein the curable interface material is an epoxy.

8. A method for coupling a male shaft with a hollow member, the method comprising:
applying a curable interface material to an outer surface of a male shaft;
assembling the male shaft in a hollow member to dispose the curable interface material in a region between the outer surface of the male shaft and an inner surface of the hollow member, the interface material contacting both the outer surface and the inner surface; and
curing the interface material in situ between the male shaft and the hollow member.

9. The method of claim 8, further comprising applying the curable interface material to the inner surface of the hollow member prior to assembling the male shaft in the hollow member.

10. The method of claim 8, wherein the curable interface material is applied to the male shaft in a liquid or semi-liquid state.

11. The method of claim 10, wherein the curable interface material remains liquid prior to curing, and thereafter forms a flexible solid barrier layer between the male shaft and the hollow member.

12. The method of claim 8, wherein the curable interface material remains liquid or semi-liquid when exposed to air, and becomes solid when removed from air.

13. The method of claim 8, wherein the curable interface material is an epoxy.

14. A method for coupling a male shaft with a hollow member, the method comprising:
applying a curable interface material to an inner surface of a hollow member;
assembling a male shaft in the hollow member to dispose the curable interface material in a region between an outer surface of the male shaft and the inner surface of the hollow member, the interface material contacting both the outer surface and the inner surface; and
curing the interface material in situ between the male shaft and the hollow member.

15. The method of claim 14, further comprising applying the curable interface material to the outer surface of the male shaft prior to assembling the male shaft in the hollow member.

16. The method of claim 14, wherein the curable interface material is applied to the hollow member in a liquid or semi-liquid state.

17. The method of claim 16, wherein the curable interface material remains liquid prior to curing, and thereafter forms a flexible solid barrier layer between the male shaft and the hollow member.

18. The method of claim 14, wherein the curable interface material remains liquid or semi-liquid when exposed to air, and becomes solid when removed from air.

19. The method of claim 14, wherein the curable interface material is an epoxy.

20. A sleeve for coupling a male shaft with a hollow member, the sleeve comprising:
a flexible, solid, self-forming layer applied between an outer surface of a male shaft and an inner surface of a hollow member in a liquid or semi-liquid state and cured in situ between the male shaft and hollow member.

21. The sleeve of claim 20, wherein the sleeve is disposed in a generally annular region between the male shaft and hollow member.

22. The sleeve of claim 20, wherein the sleeve has a thickness of between approximately 0.0005 and 0.0015 inches.

23. The sleeve of claim 20, wherein the sleeve is made of a material that remains liquid or semi-liquid when exposed to air, and becomes solid when removed from air.

24. The sleeve of claim 20, wherein the sleeve is made of an epoxy material.

25. A coupled assembly comprising:
a male shaft having an outer surface;
a hollow member having an inner surface, the male shaft being assembled in the hollow member; and
a flexible, solid, self-forming layer disposed between the outer surface of the male shaft and the inner surface of the hollow member in a liquid or semi-liquid state and cured in situ between the male shaft and hollow member.

26. The assembly of claim 25, wherein the sleeve is disposed in a generally annular region between the male shaft and hollow member.

27. The sleeve of claim 25, wherein the sleeve has a thickness of between approximately 0.0005 and 0.0015 inches.

28. The sleeve of claim 25, wherein the sleeve is made of a material that remains liquid or semi-liquid when exposed to air, and becomes solid when removed from air.

29. The sleeve of claim 25, wherein the sleeve is made of an epoxy material.
